(19) United States
(12) Patent Application Publication
(10) Pub. No.: US 2004/0143295 A1
(43) Pub. Date: Jul. 22, 2004

(54) Apparatus for placing patients in the quadruped position

(76) Inventor: Jacob Randall Ponder, West Monroe, LA (US)

Correspondence Address: JACOBSON HOLMAN PLLC, 400 SEVENTH STREET N.W., SUITE 600, WASHINGTON, DC, 20004, US

(21) Appl. No.: 10/347,415

(22) Filed: Jan. 21, 2003

(51) Int. Cl. A61G 15/00

(52) U.S. Cl. 606/237; 128/845; 606/240

(57) ABSTRACT

A quadruped positioning apparatus having a rear leg unit that is detachably and adjustably connected to a front hand unit. The rear leg unit is provided with buttocks, abductor and leg pads that allow the patient to kneel comfortably thereon, with a plurality of straps designed to secure the patient's upper and lower legs to the frame of the rear leg unit. The front hand unit is similarly provided with padding and straps, these designed to cushion and secure the patient's arms and hands when in the quadruped position. The apparatus includes multiple adjustment features to accommodate different patient heights and dimensions, and is further provided with a chest pad located between the rear and front units as a safety measure to absorb the weight of the patient in the event of collapse of the upper extremities due to fatigue.

### BACKGROUND OF THE INVENTION

1. Field of the Invention

The present invention is related to the field of physical/occupational therapy and, more particularly, to an apparatus designed to assist physical/occupational therapists in placing patients in the quadruped position for therapeutic treatment.

2. Description of the Related Art

Various techniques are used by physical/occupational therapists to treat specific body parts and muscle groups following injury, surgery, birth disorders, developmental or acquired disabilities, or neurological conditions. One such technique that facilitates the development of the patient's shoulder and hip joints, increases strength in musculature to increase proximal stability, and decreases postural abnormalities can be achieved in a quadruped position. According to the Neurodevelopmental Treatment (NDT), or Bobath approach, weight bearing in the quadruped position provides proprioceptive input to joints, and is perhaps the most effective way to normalize tone and increase function.

Positioning of the patient in quadruped position, however, can be a difficult and strenuous task. It normally takes one physical therapist to hold and control the hips and legs, two occupational therapists to position the arms, hands, shoulders and trunk, and then another person to work with the patient to perform activities that encourage the patient to look up, reach out, or shift more weight onto one side. Also, a therapist may use skilled techniques to correct orthopaedic deformities or postural alignment. For example, a ball may be held to the side of the patient with the patient being encouraged to reach over with one arm to grasp the ball. This activity to increase weight bearing on the affected extremity is an example of NDT. In order to ensure that the patient remains in proper quadruped position during activities of this nature or deformity correcting exercises, the continuing action of all four people may be required.

There are known devices for supporting and stabilizing patients in different postures for specific purposes. For example, U.S. Pat. No. 1,498,961 to German discloses a chiropractor bench for supporting a patient in the kneeling position while providing an adjustable cushioned support for the head and shoulders. This bench allows the patient to bear weight on the head and shoulder support and, because dynamic movement is accommodated, does not position the patient in a secure, supported and static position for facilitation of treatment.

U.S. Pat. No. 4,354,485 to Safadago relates to a therapeutic apparatus for the treatment of muscular and skeletal disorders. The apparatus provides a cushioned prone board that is adjustable for children of different sizes and which allows the therapist to facilitate greater range of motion and participate in a variety of environments. This device, like many in the therapeutic/rehabilitation community, is not able to secure the patient in a quadruped position, but instead positions the patient in a prone position with many points of contact for weight bearing. As a result, the apparatus is not effective for developing or inhibiting tone through weight bearing, but simply provides correctly aligned support in the prone position to allow the child to have the proximal stability required to explore his or her environment. Furthermore, the patient does not have 90 degrees of flexion in the hip or knee, and there is no means of securing the upper extremities in a static weight bearing position to facilitate treatment.

U.S. Pat. No. 4,838,249 to Jannotta is directed to a lower back therapy device for relieving back stress through cushioned support of the posterior thigh/gluteal region. Such support is necessary to enable the patient to perform routine therapeutic exercises while preventing vertebral/dorsal injury secondary to stress. Like German, Jannotta does not prevent dynamic movement of the patient and does not provide a means of imposing a static quadruped position.

Therefore, a need exists for an apparatus that allows a single therapist to position the patient in a secure, correct quadruped position and to thereafter have freedom to facilitate during the treatment session for a more effective length of time.

### SUMMARY OF THE INVENTION

In view of the foregoing, one object of the present invention is to overcome the difficulties of positioning a patient in the quadruped position with an apparatus that can be used effectively by a therapist working alone with a patient.

Another object of the present invention is to provide an apparatus for positioning an uncooperative or high maintenance patient, as well as a lower level or low functioning patient in quadruped position for NDT treatment. For the uncooperative or high maintenance patient, the apparatus provides such a level of support that he or she may feel less intimidated as compared with being manually positioned by a therapist.

A further object of the present invention is to prevent injuries to therapists and patients that can occur in the process of manually positioning the patient into the quadruped position.

Yet another object of the present invention is to provide a compact and portable device that allows caregivers and family to carry over treatment prescribed by a physician or therapist at home.

Still another object of the present invention is a quadruped positioning apparatus that provides high level, high functioning patients who have decreased trunk control, the ability to tall kneel, i.e., to maintain an upright “standing” posture while on the knees with the feet extended rearward, for treatment.

A still further object of the present invention is to provide an apparatus that is not complex in structure, can be constructed from readily available materials, and which can be manufactured at low cost but yet provide an effective rehabilatative device.

These and other objects and advantages are realized by the present invention which is directed to a quadruped positioning apparatus that is easily transported and used by a therapist working alone or with limited assistance to provide physical/occupational therapy treatment to a patient. The quadruped positioning apparatus includes a rear leg unit that is detachably and adjustably connected to a front hand unit. The rear leg unit is provided with buttocks, abductor and leg pads that allow the patient to kneel comfortably on the rear leg unit, with a plurality of straps designed to secure the patient's upper and lower legs to the frame of the rear leg unit whether the patient is in the kneeling or quadruped position. The front hand unit is similarly provided with padding and straps which are designed to cushion and secure the patient's arms and hands when in the quadruped position. A detachable belt provides additional security to the patient during treatment.

The positioning apparatus of the present invention has multiple adjustment features to accommodate different patient heights and dimensions. The apparatus is further provided with a chest pad located between the rear and front units as a safety measure to absorb the weight of the patient in the event of collapse of the upper extremities due to fatigue. This chest pad can also be used for weight bearing of bilateral upper extremities during use of the apparatus for tall kneel.

With the device according to the present invention, one or two therapists can strap the patient in but then, once set, no supporting hands are needed to maintain the patient's positioning. A single therapist can then work with the patient to have him/her shift weight, reach out, raise his/her head, correct alignment and adjust posture, throughout a range of effective neurodevelopmental activities.

These together with other objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a side view of a quadruped positioning apparatus according to the present invention;

FIG. 2 is a front view of the quadruped positioning apparatus of FIG. 1;

FIG. 3 is a top view of the quadruped positioning apparatus of FIG. 1;

FIG. 4A is a rear view of the rear leg unit of the quadruped positioning apparatus of FIG. 1, with the buttocks pad in a vertical position;

FIG. 4B is a rear view of the rear leg unit of the quadruped positioning apparatus of FIG. 1, with the buttocks pad in a horizontal position;

FIG. 5 is a side view of the quadruped positioning apparatus of FIG. 1 in use, with the buttocks pad in the horizontal position and a patient kneeling with respect thereto; and

FIG. 6 is a side view of the quadruped positioning apparatus of FIG. 1 in use, with the buttocks pad in the vertical position and a patient in the quadruped position with respect thereto.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

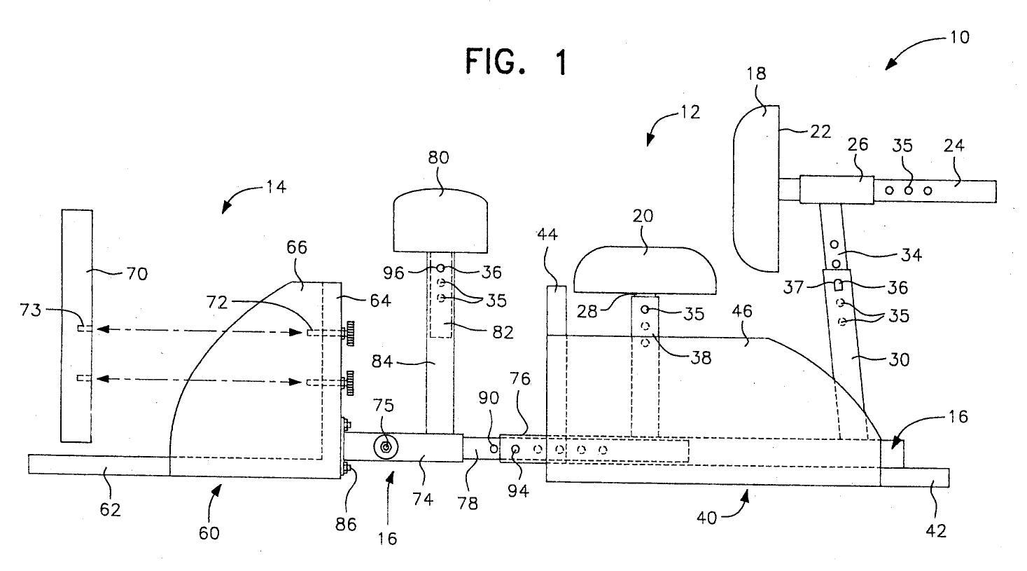

As shown in FIGS. 1-4B, the quadruped positioning apparatus of the present invention, generally designated by the reference numeral 10, includes a rear leg unit, generally designated by the reference numeral 12, and a front hand unit, generally designated by the reference numeral 14. The rear leg unit 12 and the front hand unit 14 are joined by an adjustable metal beam, generally designated by the reference numeral 16. The adjustability of the metal beam 16 allows the distance between the rear leg unit 12 and the front hand unit 14 to be varied in order to provide a proper fit for persons of different heights.

The rear leg unit 12 is provided with a buttocks pad 18 and an abductor pad 20. Connected to the underside 22 of the buttocks pad 18 is a length of metal tubing 24 that extends generally perpendicularly to the underside 22 of the pad 18. The metal tubing 24 fits within an adjustment channel 26 made of metal tubing within which it may be slideably adjusted. The adjustment channel 26 forms the upper portion of a T-shaped holder, generally designated by the reference numeral 27, with support 34 forming the base of the T-shaped holder.

The buttocks pad 18 may be adjustably mounted, through the T-shaped holder 27, to a first metal support tubing 30 that has a hollow center portion and is connected to and extends upwardly from the metal beam 16. The support 34 is inserted into and projects upwardly from the tubing 30, and is connected by a fastening element 32 to the adjustment channel 26 so as to be adjustable within and generally perpendicular thereto. By sliding the tubing 24 substantially horizontally within the channel 26, the buttocks pad 18 may be moved closer to or farther away from the abductor pad 20, allowing the rear leg unit 12 to be adjusted to fit patients of different heights. The fastening element 32 may be embodied as a screwed fitting, knobbed bolt or a wing bolt that extends through generally circular apertures in the tubing 30, support 34 and tubing 24, as appropriate, when such apertures are properly aligned. When mounted in this way, the underside 22 of the buttocks pad 18 is generally perpendicular to the floor in what is termed herein as the vertical position, an orientation suitable for a patient using the positioning apparatus 10 in the quadruped position, as illustrated in FIGS. 1-4A and 6.

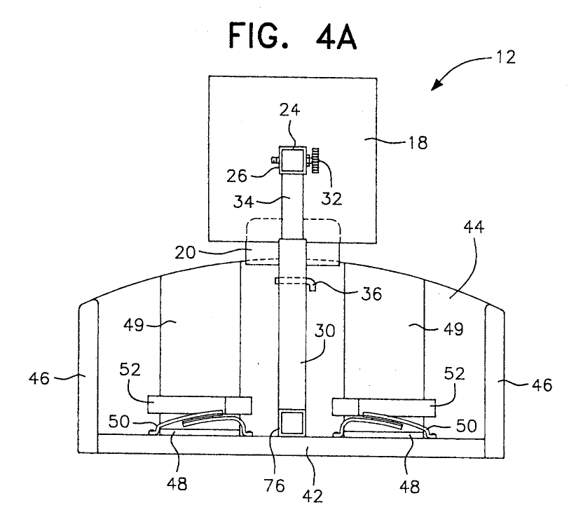

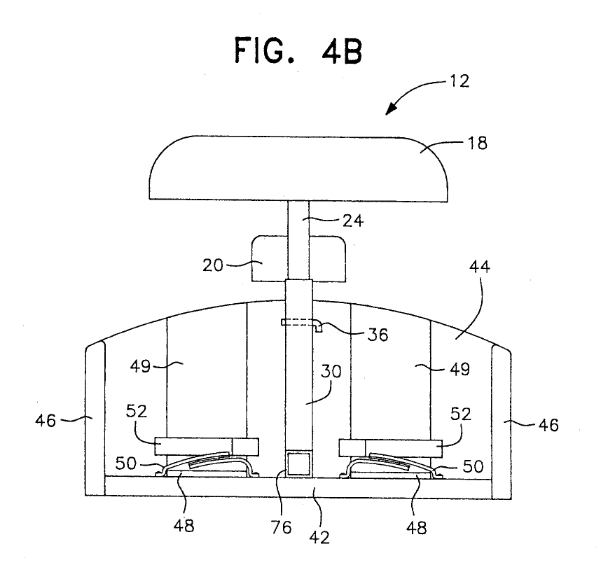

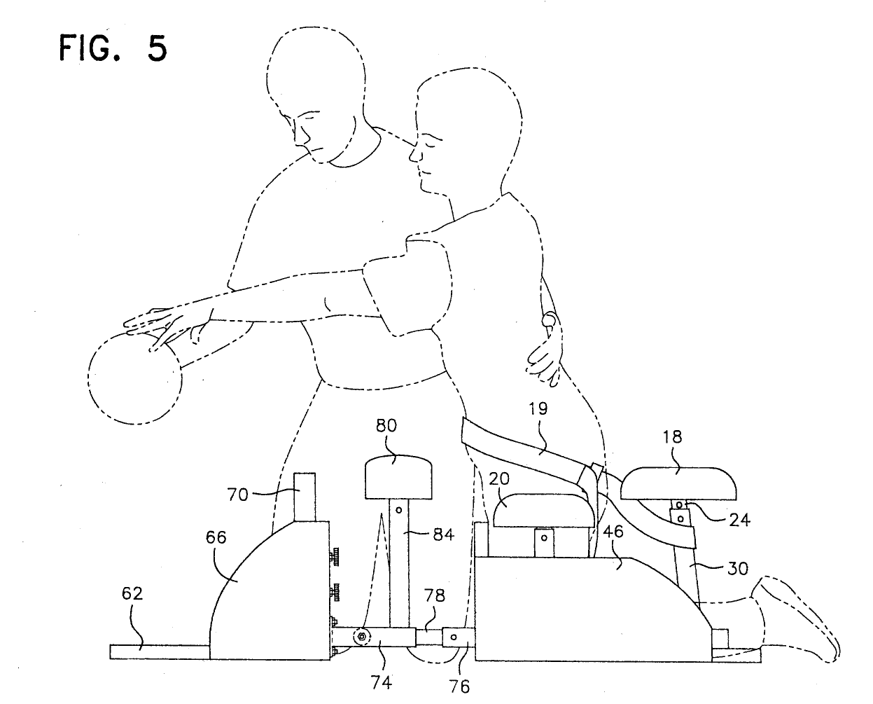

To provide an alternative mounting position, the metal tubing 24 is also sized to slide into the first metal support tubing 30 such that the buttocks pad 18 may be secured to the tubing 30 without use of the T-shaped holder. With the tubing 24 inserted directly in the first metal support tubing 30, the underside 22 of the buttocks pad 18 is generally parallel with the floor in what is termed herein the horizontal position. This horizontal orientation is typically suitable for a patient using the quadruped positioning apparatus 10 in a kneeling posture, as illustrated in FIGS. 4B and 5.

In either position, the height of the buttocks pad 18 may be adjusted by altering the extent to which the support 34 or the tubing 24, as appropriate, extends into the first metal support tubing 30 using a suitable adjustment element 36. The adjustment element 36 may be embodied as a pin, a knobbed bolt or other suitable structure that passes through selected ones of a plurality of apertures 35 in the tubing 24 or support 34, and a pair of apertures 37 in tubing 30. In the preferred embodiment, the metal tubing 30 is made of one inch square steel tubing, with the metal tubing 24 being three-quarter inch square steel tubing that fits therewithin.

The abductor pad 20 is mounted to a length of metal tubing 28 that is sized to slide into a second metal support tubing 38 that projects upwardly from and is connected to the beam 16. The upper and lower surfaces of the abductor pad 20 are generally parallel with the floor.

The extent to which the tubing 28 is inserted within the second metal support tubing 38 may be modified using an adjustment element such as a pin 36 to alter the height of the abductor pad 20. In the preferred embodiment, the metal support tubing 38 is made of one inch square steel tubing, with the metal tubing 28 being three-quarter inch square steel tubing that fits therewithin.

The rear leg unit 12 further includes an outer frame, generally designated by the reference numeral 40. The outer frame is comprised of a base member or platform 42, a front wall 44, and two side walls 46. The base member or platform 42, front wall 44 and side walls 46 are each planar, with the front wall 44 and side walls 46 mounted along respective edges to the base member 42 so as to be generally perpendicular thereto, and with each side wall connected to the front wall along an edge thereof. The frame 40 is preferably made of wood, approximately three-quarter inch thick, but could be constructed of any other suitable material.

Two leg pads 48 extend longitudinally along the upper surface of the base member 42, preferably abutting the front wall 44 at their forward end. Two additional leg pads 49 may be provided that extend vertically along the inner surface of the front wall 44. These leg pads 48, 49, which provide cushioning for at least the weight-bearing and frontal portions of the patient's knees, are best embodied using rubber padding, preferably with an adhesive backing for ease of construction to the base member 42 and front wall 44, respectively.

A first pair of flexible straps 50 is connected to the base member 42, with each strap 50 positioned to extend over a respective leg pad 48 proximate an end portion of the pad remote from the front wall 44. When a patient kneels upon the leg pads 48 with his/her knees adjacent the front wall 44, the flexible straps 50 are respectively placed over the calf regions of the patient's legs to secure the lower legs to the base member 42. The straps 50 may be of belt-type construction, a hook and loop fabric combination such as Velcro®, elastic, or any other suitable fastening structure. In a preferred embodiment, Velcro® straps are employed for easy and secure fastening and ready unfastening.

A second pair of flexible straps 52 is coupled to the front wall 44 so as to extend rearwardly from the front wall 44. When a patient kneels upon the leg pads 48 with his/her knees adjacent the front wall 44, the flexible straps 52 are respectively wrapped around the thigh regions of the patient's legs to secure the upper portion of the legs to the front wall 44. As with the first pair of straps 50, the straps 52 may be of belt-type construction, elastic, a hook and loop fabric combination such as Velcro®, or any other suitable fastening structure; however, Velcro® straps are preferred.

The first and second pairs of straps 50, 52 may be affixed to the facing surface of the base member 42 and front wall 44, respectively, or may be looped through spaced openings provided in the base member 42 and wall 44. Accordingly, each strap may be comprised of two portions individually affixed to the supporting surface or, in a preferred embodiment, may be a single member that is looped through a pair of openings in the supporting surface, one opening on either side of the pads 48, 49 supporting each of the patient's legs.

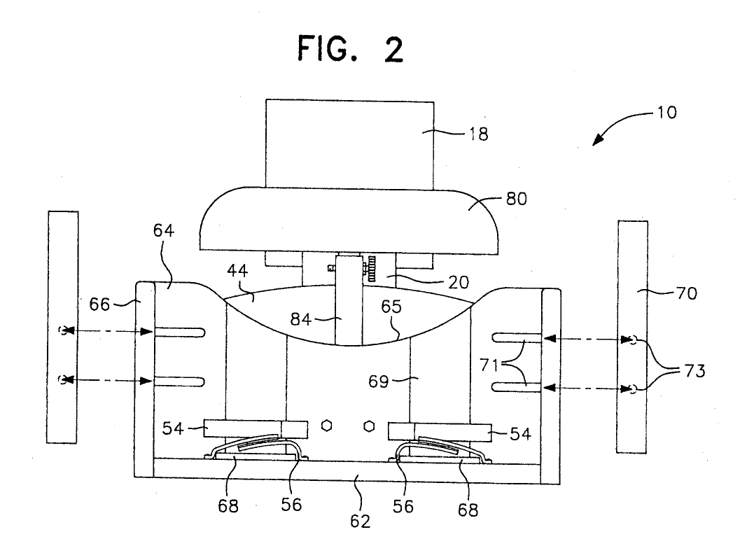

Coupled to the rear leg unit 12 is the front hand unit 14 which includes an outer frame, generally designated by the reference numeral 60, having a base member or platform 62, a rear wall 64, and two side walls 66. The base member or platform 62, rear wall 64 and side walls 66 are each planar, with the rear wall 64 and side walls 66 mounted along respective edges to the base member 62 so as to be generally perpendicular thereto, and with each side wall connected to the rear wall 64 along an edge thereof. The rear wall 64 has a generally arcuate cutout centrally located along its top edge 65, shown in FIG. 2, to accommodate the patient's chest when in the quadruped position.

Two hand pads 68 extend longitudinally along the upper surface of the base member 62, preferably abutting the rear wall 64 at their rear ends, to provide cushioning for at least the weight-bearing portion of the patient's hands when in quadruped position. Two arm pads 69 may be provided that extend along the inner surface of the rear wall 64 to provide cushioning, preferably up to at least the patient's elbows when in a quadruped position. As with the leg pads 48, 49, the hand pads 68 and arm pads 69 are preferably embodied using rubber padding adhesively adhered to the facing surface.

A third pair of flexible straps 54 is connected to the rear wall 64 so as to extend generally forwardly from the front surface of the rear wall 64. When a patient assumes the quadruped position with the palms of the hands against and supported on the hand pads 68, and with the wrists adjacent the rear wall 64, the flexible straps 54 are respectively wrapped around the wrist regions of the patient's arms to secure the lower portion of the arms against the rear wall 64.

A fourth pair of flexible straps 56 can be connected to the base member 62, with each strap 56 positioned to extend over a respective hand pad 68. When the patient has his or her palms against the hand pads 68, the flexible straps 56 are respectively placed over the tops of the palm regions of the patient's hands to secure them to the base member 62. The straps 54, 56 may be of belt-type construction, a hook and loop fabric combination such as Velcro®, or any other suitable fastening structure; however, Velcro® straps are preferred.

As with the straps of the rear leg unit 12, the third and fourth pairs of straps 54, 56 may be affixed to the supporting surface of the rear wall 64 and base member 62, respectively, or may be looped through spaced openings provided therein. Accordingly, each strap may be comprised of two portions individually affixed to the supporting surface or, in a preferred embodiment, may be a single elongated member that is looped through a pair of openings in the supporting surface, one opening on either side of the pads 68, 69 supporting each of the patient's hands and lower arms, respectively.

The front hand unit 14 further preferably includes at least two outer arm cushions 70 that are mounted to the rear wall 64 and adjacent a respective side wall 66. In the preferred embodiment, the height of the arm cushions 70 is greater than the height of the rear and side walls 64, 66 to provide outer support along a greater portion of the patient's arms. Each cushion is preferably coupled to the rear wall 64 using at least two knobbed bolts 72 received in apertures 73 in the cushion 70. The bolts 72 slideably extend through appropriately sized horizontal slots 71 in the rear wall so that the positioning of the cushions 70 can be varied relative to the side walls 66 to either abut the side walls or be spaced therefrom. Inward positioning of cushions 70 can accommodate smaller patients to support the outside of their arms when in the quadruped position.

The rear leg unit 12 and the front hand unit 14 are adjustably and removably connected to one another by the metal beam 16. The beam 16 includes a front section 74 and a rear section 76, each section preferably being hollow to receive a connector section 78. The front section 74 is fixedly connected to the rear wall 64 of the front hand unit 14 by any suitable fastening element, such as plate and bolts 86. While in the preferred embodiment the beam is made of square metal tubing, other materials of suitable strength and rigidity could be used.

The connector section 78 has a plurality of aligned apertures 90 in the side walls thereof and is preferably fixed to the front section 74 of the beam 16, as by a bolt element 75. The other end of connector section 78 is in sliding engagement with the rear section 76. The distance between the rear leg unit 12 and the front hand unit 14 is determined by the extent to which the connector section 78 is inserted within the rear section 76. When a desired distance is obtained, the connector section 78 is secured at the closest insertion position within the rear section 76 using an adjustment element 92. Adjustment element 92 is preferably a pin or knobbed bolt that extends through a pair of aligned apertures 94 in the rear section 76 to align with a desired pair of the plurality of apertures 90 in the connector section 78. When a different distance is desired, the adjustment element 92 may be readily removed, the connector section 78 slid further into or out of the rear section 76 as necessary to bring a different pair of connector section apertures 90 into alignment with the pair of apertures 94 in the rear section 76, and the adjustment element 92 then reinserted therein.

Affixed to the front section 74, and extending upwardly therefrom, is a third metal support tubing 84 having a hollow center portion. A chest pad 80 supported on a length of metal tubing 82 is inserted within the third metal support tubing 84 for mounting thereto in the same manner as tubing 28 is inserted within the second metal support tubing 38. The height of the chest pad 80 may also be adjusted by altering the extent to which the tubing 82 extends into the support tubing 84 and then securing the tubing 82 at that level using an adjustment element 36. The adjustment element 36 may be embodied as a pin that passes through selected ones of a plurality of apertures 35 in the tubing 82 and a pair of apertures 96 in third metal support tubing 84.

In the preferred embodiment of the present invention, the front and rear sections 74, 76 of the beam 16 are made of one inch square steel tubing, with the connector section 78 being three-quarter inch square aluminum tubing that fits therewithin. The buttocks, abductor and chest pads are made of foam rubber or other cushioning material covered with cloth or preferably vinyl for easy care and cleaning. Standard fastening elements including welding, screws, bolts, putty, glue, etc., provide the necessary fastening functions as would be known by persons of skill in the art.

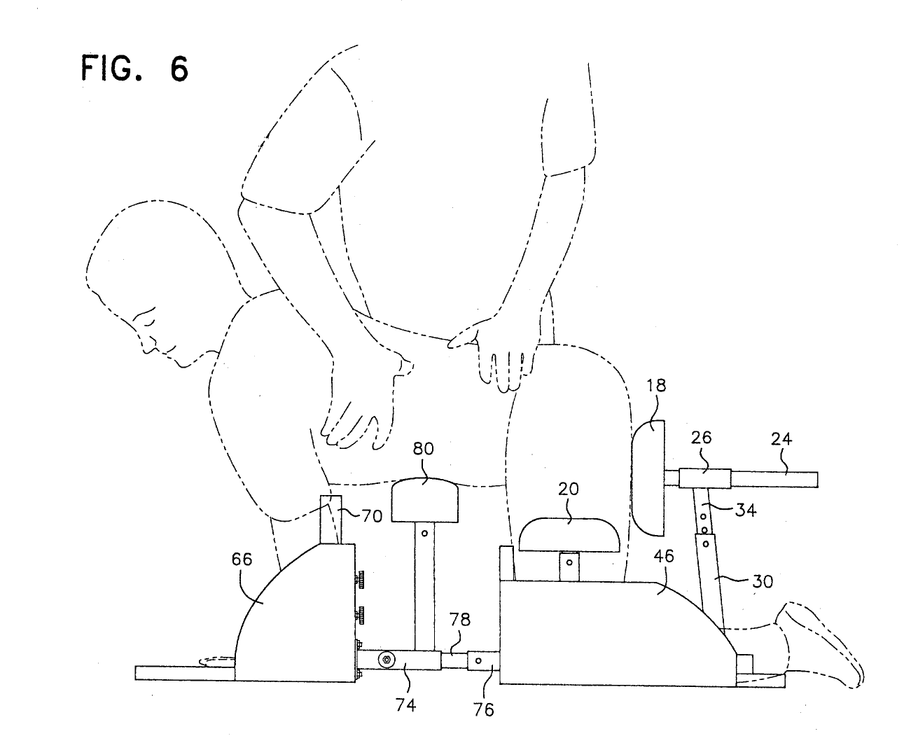

In use of the present invention, as representatively shown in FIGS. 5 and 6, the distance between the front hand unit and the rear leg unit is adjusted as necessary for each patient. The patient kneels upon the base member or platform 42 of the rear leg unit 12 with his/her knees adjacent the front wall 44. Pads 48, 49 cushion the patient's knees and thighs, respectively. The straps 50 are fastened around the calf area of the lower legs, and the straps 52 are fastened around the lower thigh region. The abductor pad 20 is adjusted to a comfortable height so as to fit between the patient's legs. Should the patient desire or require therapy in the kneeling position, the buttocks pad 18 is mounted in the horizontal position to allow the patient to lean or sit thereon. A safety belt 19 is preferably wrapped around the patient's waist and the metal tubing 24, 30 supporting the buttocks pad 18, as shown in FIG. 5. This belt may be tightened as necessary to better secure the patient's position.

If the full quadruped position is utilized, the buttocks pad 18 is mounted in the vertical position to provide a limit and support for the buttocks of the patient when rocking backward on the hands and knees. Once strapped into the rear leg unit as just previously described, the patient's hands are placed, palms down, on the base member 62 of the front hands unit 14 with the wrists adjacent the rear wall 64 and the fingers extending forward, away from the rear wall 64. Pads 68, 69 cushion the patient's palms and arms, respectively. The straps 54 are fastened around the wrist area, and the straps 56 are fastened over the hands. The cushions 70 may be adjusted inwardly from the side walls 66 in the slots 71 as necessary to provide good side support to the patient's arms. In this position, the safety belt 19 is best adjusted around the patient's upper thighs and the metal tubing 24, 30 supporting the buttocks pad 18 (not shown).

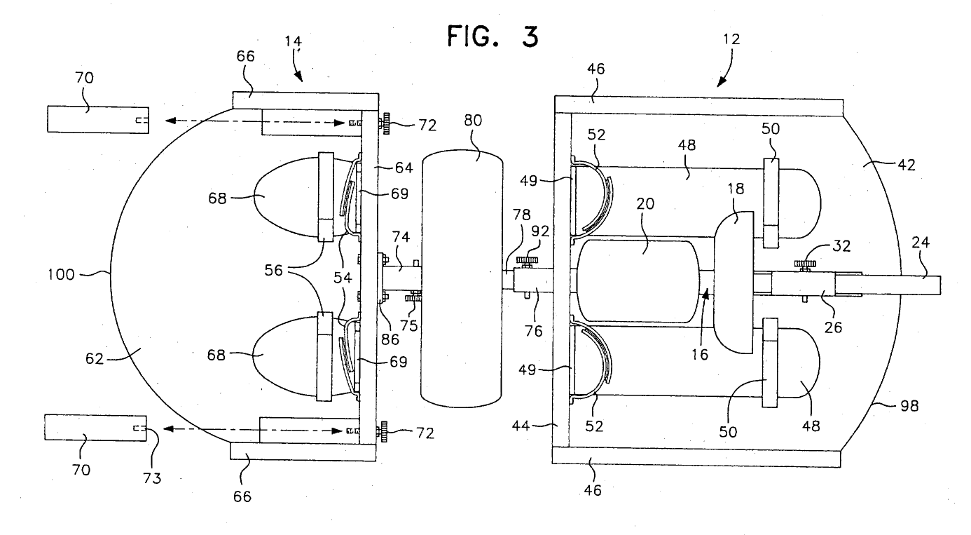

The chest pad 80 is positioned at a height that does not allow the patient to distribute weight thereon when his or her arms are extended such that the patient's back is generally parallel with the floor. Instead, the chest pad 80 is provided as a safety precaution to absorb the weight of the patient should the patient's upper extremities become fatigued and give out while in the quadruped position. Further, it will be seen in FIG. 3 that the rear edge 98 of the base member 42 and the forward edge 100 of the base member 62 are preferably curved or arcuate, although this is not necessary as other perimeter shapes could also be used.

In either of the kneeling or quadruped positions, as shown in FIGS. 5 and 6, respectively, the patient may be effectively worked with by a single therapist. The quadruped positioning apparatus ensures that the patient's position remains as desired throughout a course of therapy. By having the patient reach back or around to grasp an object, whether while kneeling or with one hand free but in the quadruped position, muscles may be effectively toned and coordination developed. Various exercises and stretches that may be advantageously performed while the patient is in the quadruped positioning apparatus will be or become apparent to therapists having skill in the rehabilitation field.

The foregoing descriptions and drawings should be considered as illustrative only of the principles of the invention. The invention may be configured in a variety of shapes, sizes, and materials, and is not limited by the dimensions of the preferred embodiment. For example, the materials used, the shape and the size of the quadruped positioning apparatus may vary, as may the length and shape of the cushions and padding. Wedges or other forms of cushioning may be added for extra support and/or comfort, and additional straps may be employed to ensure correct positioning of the patient. Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. An apparatus for positioning a patient in a quadruped position comprising:
a rear leg unit having a rear frame and a first plurality of straps connected thereto for securing the patient's legs in a kneeling position to said rear frame;
a front hand unit having a front frame and a second plurality of straps connected thereto for securing the patient's upper extremities in an extended position to said front frame; and
an interconnecting element coupled to said front and rear units for adjusting a distance therebetween to accommodate the patient in the quadruped position.

2. The apparatus as set forth in claim 1, wherein said rear frame includes a planar base member for supporting the patient's knees and a front wall oriented substantially perpendicular to said base member so as to be generally parallel with the patient's thighs, said first plurality of straps including a pair of straps connected to said front wall for encircling and securing the patient's thighs to said front wall.

3. The apparatus as set forth in claim 2, wherein said first plurality of straps further includes a second pair of straps connected to said base member for encircling and securing the patient's lower legs to said base member.

4. The apparatus as set forth in claim 2, wherein said rear leg unit further comprises a buttocks pad coupled to said interconnecting element through an adjustable pedestal, said buttocks pad having a horizontal position for use with a kneeling patient and a vertical position for use with a patient in the quadruped position.

5. The apparatus as set forth in claim 4, wherein said rear leg unit further comprises an abductor pad coupled to said interconnecting element through a height-adjustable pedestal, said abductor pad located between said buttocks pad and said front wall for fitting between the patient's legs.

6. The apparatus as set forth in claim 2, wherein said base member includes pads extending substantially perpendicularly from said front wall for cushioning at least a weight-bearing portion of the patient's knees.

7. The apparatus as set forth in claim 2, wherein said base member includes pads extending substantially perpendicularly from said base member for cushioning a frontal portion of the patient's upper legs.

8. The apparatus as set forth in claim 1, wherein said front frame includes a planar base member for supporting the patient's hands and a rear wall oriented substantially perpendicular to said base member so as to be generally parallel with the patient's arms, said second plurality of straps including a pair of straps connected to said rear wall for encircling and securing the patient's lower arms to said front wall.

9. The apparatus as set forth in claim 8, wherein said second plurality of straps further includes a second pair of straps connected to said base member for encircling and securing the patient's hands to said base member.

10. The apparatus as set forth in claim 9, further comprising a pair of cushions coupled in an adjustably spaced apart arrangement to said rear wall for cushioning and supporting the patient's arms.

11. The apparatus as set forth in claim 8, wherein said base member includes pads extending substantially perpendicularly from said rear wall for cushioning at least a weight-bearing portion of the patient's hands.

12. The apparatus as set forth in claim 8, wherein said base member includes pads extending substantially perpendicularly from said base member for cushioning at least the patient's elbows.

13. The apparatus as set forth in claim 1, further comprising a chest pad coupled to said interconnecting element through a height-adjustable pedestal and located between said rear leg unit and said front hand unit.

14. An apparatus for positioning a patient in a quadruped position comprising:
a rear leg unit having a rear frame for supporting the patient's legs in a kneeling position on said rear frame, a buttocks pad having a horizontal position for use with a patient in a kneeling position and a vertical position for use with a patient in the quadruped position, and an abductor pad located forwardly of said buttocks pad for fitting between the patient's legs;
a front hand unit having a front frame for supporting the patient's upper extremities in an extended position on said front frame;
an adjustable beam coupled to said front and rear units for adjusting a distance therebetween to accommodate the patient in the quadruped position; and
a chest pad coupled to said beam through a height-adjustable pedestal and located between said rear leg unit and said front hand unit.

15. The apparatus as set forth in claim 14, wherein said buttocks pad and said abductor pad are each coupled to said beam through a respective height-adjustable pedestal.

16. The apparatus as set forth in claim 14, wherein said rear frame includes a planar base member for supporting the patient's knees and a front wall oriented substantially perpendicular to said base member so as to be generally parallel with the patient's thighs, a first pair of straps connected to said front wall for encircling and securing the patient's thighs to said front wall, and a second pair of straps connected to said base member for encircling and securing the patient's lower legs to said base member.

17. The apparatus as set forth in claim 16, wherein said base member includes pads extending substantially perpendicularly from said front wall for cushioning at least a weight-bearing portion of the patient's knees, and further pads extending substantially perpendicularly from said base member for cushioning a frontal portion of the patient's upper legs.

18. The apparatus as set forth in claim 14, wherein said front frame includes a planar base member for supporting the patient's hands and a rear wall oriented substantially perpendicular to said base member so as to be generally parallel with the patient's arms, a first pair of straps connected to said rear wall for encircling and securing the patient's lower arms to said front wall, and a second pair of straps connected to said base member for encircling and securing the patient's hands to said base member.

19. The apparatus as set forth in claim 18, further comprising a pair of cushions coupled in an adjustably spaced apart arrangement to said rear wall for cushioning and supporting the patient's arms.

20. The apparatus as set forth in claim 18, wherein said base member includes pads extending substantially perpendicularly from said rear wall for cushioning at least a weight-bearing portion of the patient's hands, and further pads extending substantially perpendicularly from said base member for cushioning at least the patient's elbows.
